(19) United States
(12) Patent Application Publication
(10) Pub. No.: US 2026/0113205 A1
(43) Pub. Date: Apr. 23, 2026

(54) Seamlessly Transitioning to Post-Quantum Cryptography (PQC) in Digital Certificate Management

(71) Applicant: DigiCert, Inc., Lehi, UT (US)

(72) Inventors: Jarryd Jermaine Chengalroyen, Cape Town (ZA); Avesta Hojjati, Austin, TX (US)

(73) Assignee: DigiCert, Inc., Lehi, UT (US)

(21) Appl. No.: 18/917,238

(22) Filed: Oct. 16, 2024

(51) Int. Cl. H04L 9/32

(52) U.S. Cl. CPC H04L 9/3265; H04L 9/3249

(57) ABSTRACT

Systems and methods are provided for issuing digital certificates and promoting cybersecurity. According to one implementation, a method, executed by an end entity, includes a step of, responsive to receiving input from a user associated with the end entity, the input configured to set a flag, detecting a certificate replacement condition in which a current digital certificate issued to the end entity is ready to be reissued or replaced. The flag is configured to signify an intent to automatically transition the end entity to a different cryptography scheme. In response to determining that the flag is set when the certificate replacement condition is detected, the method further includes a step of automatically transitioning from a current cryptography scheme established over a current certificate chain to a new cryptography scheme established over an alternate certificate chain.

### FIELD OF THE DISCLOSURE

The present disclosure relates generally to networking and cryptography. More particularly, the present disclosure relates to systems and methods for managing digital certificate policies by seamlessly transitioning to Post-Quantum Cryptography (PQC) schemes.

### BACKGROUND

Digital certificates (e.g., public key certificates, identity certificates, etc.) are electronic documents issued by trusted Certificate Authorities (CAs) for verifying the identity of a user, device, or server. Digital certificates are configured to enable secure online data exchange and communications using encryption and decryption policies. Most of the current encryption algorithms used in digital certificates (e.g., RSA, ECC, DSA, SHA-2) are not quantum-resistant and could be broken by quantum computers. The cryptographic community is actively working on Post-Quantum Cryptographic (PQC) algorithms that will be resistant to quantum attacks, and these algorithms will replace or complement existing cryptography in the near future.

### BRIEF SUMMARY

The present disclosure relates to systems and methods for managing digital certificate policies and transitioning to stronger encryption algorithms in order to promote security within a network. A method to be executed by an end entity may be implemented for automatically and seamlessly transitioning to a new cryptography scheme. According to one embodiment, the method may include a step of receiving input from a user associated with the end entity, wherein the input is configured to set a flag during a certificate enrollment setup phase. The flag is configured to signify an intent to automatically transition the end entity to a different cryptography scheme. The method further includes a step of detecting a certificate replacement condition in which a current digital certificate issued to the end entity is ready to be reissued or replaced. In response to determining that the flag is set when the certificate replacement condition is detected, the method includes a step of automatically transitioning from a current cryptography scheme established over a current certificate chain to a new cryptography scheme established over an alternate certificate chain.

In some embodiments, the method may further include a step of receiving a new digital certificate encrypted with the new cryptography scheme from a CA via the alternate certificate chain for replacing the current digital certificate. The step of automatically transitioning from the current cryptography scheme to the new cryptography scheme may include a seamless transition from the current digital certificate to the new digital certificate. Before automatically transitioning from the current cryptography scheme to the new cryptography scheme, the method may further include a) determining if hardware and/or software resources of the end entity include capabilities sufficient to handle the new cryptography scheme, and b) upon confirming that the hardware and/or software resources include sufficient capabilities, transitioning to the new cryptography scheme. Also, according to some implementations, the action of confirming sufficient capabilities may include exchanging data with a CA via a handshaking procedure performed during the certificate enrollment setup phase.

Furthermore, according to some embodiments, the current cryptography scheme described herein may be a classical or legacy cryptography scheme, and the new cryptography scheme described herein may be a Post-Quantum Cryptography (PQC) scheme. The classical or legacy cryptography scheme, for example, may include one or more of RSA, ECC, SSL, and TLS encryption. In other embodiments, the current cryptography scheme described herein may be a Post-Quantum Cryptography (PQC) scheme, and the new cryptography scheme described herein may be an alternative PQC scheme (e.g., PQC developed in the future that can be used). The PQC scheme, for example, may include one or more of lattice-based, hash-based, multivariate polynomial, SLH-DSA, SPHINCS+, ML-DSA, and/or Dilithium encryption, and the alternative PQC scheme, for example, may include a greater level of encryption than the PQC scheme.

In some embodiments, the current certificate chain and alternate certificate chain may be established as parallel chains. Each of the current certificate chain and alternate certificate chain, for instance, may be a trust hierarchy having one or two Roots or Certificate Authorities (CAs) at the top of the trust hierarchy and one or more Intermediate CAs (ICAs) positioned between an associated Root and the end entity in the trust hierarchy. A Root certificate is issued to each Root and an ICA certificate is issued to each ICA. The end entity, according to various implementations, may be associated with a server, web server, Content Delivery Network (CDN), and/or client-to-client device configured for Transport Layer Security (TLS) or mutual TLS (mTLS) communications with users or clients. The end entity, according to other implementations, may be associated with an Internet of Things (IoT) device, embedded device, Trusted Platform Module (TPM), Online Certificate Status Protocol (OCSP) responder, and/or Hardware Security Module (HSM). HSMs, also referred to as “roots of trust,” are physical devices that protect cryptographic keys and data used for encryption, decryption, authentication, and digital signing. They also prevent unauthorized users from accessing sensitive data, safeguard and manage secrets (e.g., keys), perform encryption and decryption functions for digital signatures, etc.

The certificate replacement condition may be defined as one or more of a) an impending expiration of the current digital certificate, b) an impending due date for renewal of a key pair of the current digital certificate, c) availability of the new cryptography scheme, d) changes in the current certificate chain, e) availability of the alternate certificate chain, f) an upgrade to hardware and/or software resources associated with the end entity, g) changes in organizational parameters associated with the end entity, h) revocation of the current cryptography scheme, and i) detection of one or more vulnerabilities or compromises of the current cryptography scheme. Furthermore, according to various implementations, the certificate enrollment setup phase may be related to a key negotiation or key exchange phase of a certificate management process and/or may be related to preparing and transmitting a CSR from the end entity to a CA. The method may further be defined whereby the new cryptography scheme and alternate certificate chain are configured to comply with public trust standards, protocols, and regulations defined by the National Institute of Standards and Technology (NIST), the Cybersecurity and Private Professionals (CAPP) Forum, and/or the Commercial National Security Agency (CNSA).

### BRIEF DESCRIPTION OF THE DRAWINGS

The present disclosure is detailed through various drawings, where like components or steps are indicated by identical reference numbers for clarity and consistency.

FIG. 1 is a block diagram illustrating a system defining a certificate chain, according to various embodiments.

FIG. 2 is a block diagram illustrating a certificate chain arranged for issuing hybrid certificates, according to various embodiments.

FIG. 3A-3C are block diagrams illustrating certificate chains arranged in parallel, according to various embodiments.

FIG. 4 is a diagram illustrating an enrollment setup page, according to various embodiments.

FIG. 5 is a block diagram illustrating a computing system of a Certificate Authority (CA) or end entity, according to various embodiments.

FIG. 6 is a flow diagram illustrating a method for setting up an automatic transitioning mode, according to various embodiments.

FIG. 7 is a flow diagram illustrating a method upgrading cryptography when it is determined that a certificate is ready to be replaced or reissued, according to various embodiments.

FIG. 8 is a flow diagram illustrating a method to be executed by an end entity for automatically and seamlessly transitioning to a new cryptography scheme, according to various embodiments.

### DETAILED DESCRIPTION

Digital certificates may use different types of encryption algorithms to ensure the security and authenticity of communications: a) symmetric encryption algorithms and b) asymmetric encryption algorithms. Asymmetric encryption, also known as public key encryption, involves a key pair including a public key and a private key. The public key is shared openly, while the private key is kept secret. Common asymmetric encryption algorithms include a) Rivest-Shamir-Adleman (RSA), which relies on the mathematical difficulty of factoring large prime numbers, b) Elliptic Curve Cryptography (ECC), such as the Elliptic Curve Digital Signature Algorithm (ECDSA), which is based on the mathematics of elliptic curves, and c) Digital Signature Algorithm (DSA), which is used primarily for digital signatures in certificates.

Symmetric encryption algorithms use a single key for both encryption and decryption. In the context of digital certificates, symmetric encryption is used to secure the actual data during transmission after a secure key exchange has taken place using asymmetric encryption. Advanced Encryption Standard (AES) is the most widely used symmetric encryption algorithm and may be used to encrypt data during actual sessions. In addition, hashing algorithms, essentially used in the context of digital certificates, may be used for creating secure digital signatures. A common hashing algorithm is Secure Hash Algorithm 2 (SHA-2), among others, which is commonly used in conjunction with RSA or ECC to create a digital signature by hashing the message before it is signed to ensure data integrity and authenticity.

However, most of the current encryption algorithms widely used today, such as RSA, ECC, and SHA-2, are not considered to be “quantum-resistant. ” That is, quantum computers, once fully realized, are expected to be able to break many of these encryption methods due to their ability to perform certain mathematical operations much faster than classical or legacy computers. For example, RSA may be vulnerable to Shor's algorithm, which is a quantum algorithm capable of factoring large numbers exponentially faster than classical algorithms. Thus, Shor's algorithm would render RSA insecure once large-scale quantum computers become practical. ECC and DSA might also be broken by quantum computers using Shor's algorithm.

AES, as a symmetric encryption algorithm, is more resilient to quantum attacks compared to asymmetric algorithms. However, Grover's algorithm, a quantum algorithm for unstructured search, can speed up brute-force attacks on symmetric keys, which means that the effective security level of AES would be cut in half. Similar to AES, Grover's algorithm could be used to attack SHA-2 by performing hash collisions faster than classical computers. However, the quantum speedup is quadratic, meaning the hash length would need to be doubled to maintain security. For instance, SHA-256 would require the use of SHA-512 to remain secure against quantum attacks.

To address these vulnerabilities, cryptographic researchers are developing post-quantum algorithms, which are designed to be resistant to attacks from quantum computers. Some of the leading approaches in post-quantum cryptography (PQC) include a) lattice-based cryptography, b) code-based cryptography, c) hash-based cryptography, d) multivariate quadratic equations, and e) super-singular isogeny-based cryptography. Lattice-based algorithms, such as CRYSTALS, Dilithium (for digital signatures), and Kyber (for key encapsulation), are believed to be quantum-resistant. These algorithms rely on the hardness of lattice problems, which are thought to be difficult for both classical and quantum computers to solve. Code-based cryptography may include algorithms like McEliece (for encryption), which are based on error-correcting codes and are considered resistant to quantum attacks. Hash-based cryptography include hash-based signature schemes, such as XMSS (eXtended Merkle Signature Scheme) and SPHINCS+, and are also considered quantum-safe because their security relies on the hardness of finding collisions or preimages in hash functions, which are believed to be secure against quantum computers. Multivariate quadratic equations may use schemes based on solving multivariate quadratic equations, such as Rainbow (for digital signatures). Super-singular isogeny-based cryptography, such as Super-singular Isogeny Key Encapsulation (SIKE) is currently being researched. The National Institute of Standards and Technology (NIST) is in the process of developing Post-Quantum Cryptography (PQC) standards for defending against quantum threats.

Therefore, a goal of the present disclosure is to provide systems and methods for seamlessly transitioning from classical or legacy algorithms to Post-Quantum Cryptography (PQC), particularly in the field of digital certificates and certificate policy management. The embodiments described herein are configured to avoid performance issues related to both “hybrid” certificates and purely parallel chain certificates, such as by using configurations that allows clients to create an alternative certificate chain and transition based on a flag that is set, such as during the certificate policy setup. The systems and methods of the present disclosure are configured to assist users with certificate enrollment phases to allow clients to create an alternative certificate chain, which may then enable a seamless and hands-free switching or swapping procedure to PQC. Thus, when a specific flag (described below) is set in the certificate policy setup, the automatic and seamless transition can take place. Again, the embodiments described herein are configured to avoid the performance drawbacks associated with hybrid certificates that use dual encryption on a single path. That is, a first certificate chain with classical encryption now, and then automatically switching to a second certificate chain with PQC at expiry.

### General Certificate Chain

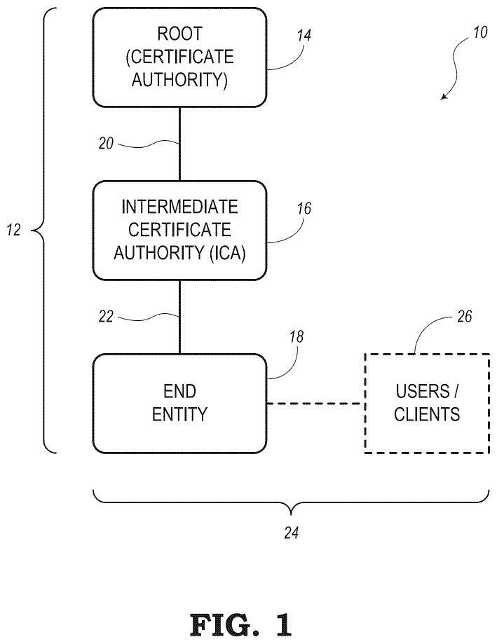

FIG. 1 is a block diagram illustrating an embodiment of a system 10 defining a certificate chain. In this embodiment, the system 10 includes a certificate chain 12 (or certificate hierarchy), particularly for issuing digital certificates to a client. The certificate chain 12 includes a Root 14 (e.g., Certificate Authority (CA) or Root CA, such as DigiCert), one or more Intermediate CAs (ICAs) 16, and an end entity 18. Although only one ICA 16 is shown, it should be noted that more than one ICA may be arranged between the Root 14 and the end entity 18. The Root 14 includes a self-signed Root certificate, each ICA 16 includes an ICA certificate, and the end entity 18 is issued a certificate by the Root 14 and/or ICAs 16. Essentially, an end entity is the basic holder and owner of a certificate, whether this is an actual person, a device, server, etc. Link 20 enables the Root 14 and ICAs 16 to communicate certificate related information. Link 22 enables the ICAs 16 and end entity 18 to communicate certificate related information.

In the certificate chain 12, each entity plays a distinct role in establishing and maintaining a trusted system for digital certificates. The certificate chain 12 helps ensure the authenticity and trustworthiness of certificates issued to end entities (e.g., the end entity 18 or other end users). The Root 14 is the top-level trusted authority in the certificate chain 12 and serves as the foundation of trust for all certificates issued in the chain. It is the ultimate trust anchor that signs and issues certificates to lower-tier entities, usually the ICAs 16. The ICAs 16 act as intermediaries between the Root 14 and the end entity 18. They issue certificates to other ICAs 16 or directly to the end entity 18. The Root 14 can delegate certificate issuance responsibilities to these ICAs 16 to reduce risk and better manage certificate issuance. The end entity 18, among other end entities, is a recipient of a digital certificate and represents the final link in the certificate chain 12. The end entity 18 may be a server, website, individual, user device, system, etc. that may use a certificate to prove its identity and enable secure communication with users and clients.

For example, when implemented as a web server, the end entity 18 may be in communication with a plurality of users/clients 22 via Transport Layer Security (TLS) paths 24 within a communication network. In some embodiments, the end entity 18 may be configured as an Internet of Things (IoT) device, embedded device, Trusted Platform Module (TPM), Online Certificate Status Protocol (OCSP) responder, router, individual, end user device, etc. and may not necessarily include communication with the user/clients 22. In other embodiments, the end entity 18 may be configured as a web server, server, or Content Delivery Network (CDN) and may be configured to communicate with the users/clients 22 via the TLS paths 24. A CDN, for example, may refer to a network of servers that delivers content to users by caching and storing the content in data centers to distributed locations near the users, which can be implemented in order to speed up the delivery of web content, resulting in faster page load times and a better web experience. Also, while TLS is used herein as an example, those skilled in the art will appreciate other technologies are also contemplated, e.g., SSL and the like.

Regarding an example in which the end entity 18 is a web server, the users/clients 22 may verify the identity and legitimacy of the end entity 18 using the associated digital certificate. When a user/client 22 uses his or her browser to visit a secure website (e.g., using https), the end entity 18 may provide its end entity certificate (i.e., issued by an ICA 16), the browser validates the certificate by checking the signature, and follows the chain of trust (e.g., up the certificate chain 12 through the ICA 16 and Root 14) to check the ICA 16 to determine if the issued end-entity certificate is valid and to check the Root 14 to determine if the issued ICA certificate is valid. If the entire chain is valid and trusted by the browser, communication over the TLS path 24 is able to proceed securely.

In some embodiments, the TLS paths 24 may include mutual TLS (mTLS) communication, which may include a specific type of TLS handshaking procedure where both the end entity 18 and the user/client 22 communicate in the client-to-client type of manner and each entity is configured to authenticate the certificate of the other client. It goes beyond standard TLS by requiring each party to prove its identity, thus ensuring a bidirectional verification process in order to establish mutual authentication.

### Hybrid Certificates

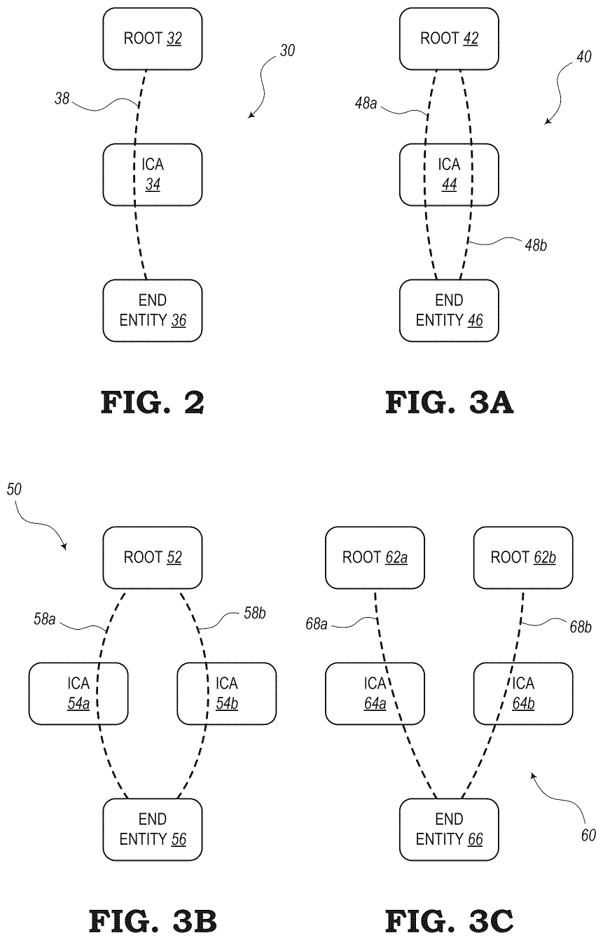

FIG. 2 is a block diagram illustrating an embodiment of a hybrid certification system 30 arranged for issuing hybrid certificates (i.e., one classical certificate and one quantum-ready certificate). The certificate chain 30 includes a Root 32, an ICA 34 (or multiple ICAs), and an end entity 36. With respect to the concept of transitioning from one type of cryptography (e.g., using classical or legacy encryption and algorithms) to another type of cryptography (e.g., PQC), hybrid systems are intended to improve upon systems that use two parallel certificate chains. However, hybrid systems introduce other issues with respect to certificate transitioning. For example, both hybrid systems and parallel path systems include complexities and require large amounts of computational power.

In a hybrid approach, instead of having two chains, the hybrid certification system 30 includes one certificate chain 38 involving the Root 32, ICA 34, and end entity 36. In some embodiments, there may be four different ways to implement a hybrid strategy for certificate transitioning while serving both classical and PQC algorithms.

In private trust systems in which the end entity 36 represents a domain-centric system for serving users within an organization, any type of cryptography may be used. However, in public trust systems in which the end entity 36 represents a server or web server that serves external users, cryptography needs to comply with specific protocols and standards. Presently, public trust systems cannot implement hybrid systems, such as the hybrid certification system 30, although new protocols, standards, and regulations may soon allow such strategies.

Nevertheless, the hybrid certification system 30 may implement four different strategies. One strategy may be referred to as “hybrid/catalyst,” which is configured to modify an extension in an X.509 certificate. Another strategy may be referred to as “chameleon,” which includes issuing two certificates at the same time, issued from the same Root 32 or different roots. Another strategy may be referred to as “composite,” which includes combining two signatures together. A fourth strategy may be referred to as “Merkle Tree,” which includes putting the signature of the PQC on a certificate transparency log.

### Parallel Certificate Chains

FIG. 3A-3C are block diagrams illustrating embodiments of parallel systems having certificate chains arranged in parallel. In FIG. 3A, a parallel system 40 includes one Root 42, one ICA 44 (or multiple ICAs in one path), and an end entity 46, whereby a first certificate chain 48a (e.g., pure classical cryptography) and a second certificate chain 48b (e.g., pure PQC) both involve the one Root 42, ICA 44, and the end entity 46. In FIG. 3B, a parallel system 50 includes one Root 52, two ICAs 54a, 54b (or multiple ICAs in each path), and an end entity 56, whereby a first certificate chain 58a (e.g., pure classical cryptography) involves the one Root 52, the first path of ICAs 54a, and the end entity 56 and a second certificate chain 58b (e.g., pure PQC) involves the one Root 52, the second path of ICAs 54b, and the end entity 56. In FIG. 3C, a parallel system 60 includes two Roots 62a, 62b, corresponding ICAs 64a, 64b (or corresponding paths of multiple ICAs), and an end entity 66, whereby a first certificate chain 68a (e.g., pure classical cryptography) involves the first Root 62a, the first set of ICAs 64a, and the end entity 66 and a second certificate chain 68b (e.g., pure PQC) involves the second Root 62b, the second set of ICAs 64b, and the end entity 66.

Thus, the parallel systems 40, 50, 60 provide an alternative to using hybrid certificates as described with respect to FIG. 2, which combine both classical and quantum-safe cryptography. In FIG. 3A-3C, transitioning from one certificate to another involves transitioning from one certificate path 48a, 58a, 68a to the other 48b, 58b, 68b, respectively. Of course, this may include fully transitioning from quantum-unprotected to quantum-safe certificates. Again, these quantum-safe certificates may rely on quantum-resistant algorithms, such as lattice-based cryptography, hash-based cryptography, and/or multivariate polynomial cryptography, to ensure security against future quantum computing threats. Unlike hybrid certificates, which are designed to be backward-compatible with current systems using traditional cryptography, quantum-safe certificates focus entirely on future-proofing encryption.

### Certificate Signing Requests (CSRs) and Certificate Enrollment Policies

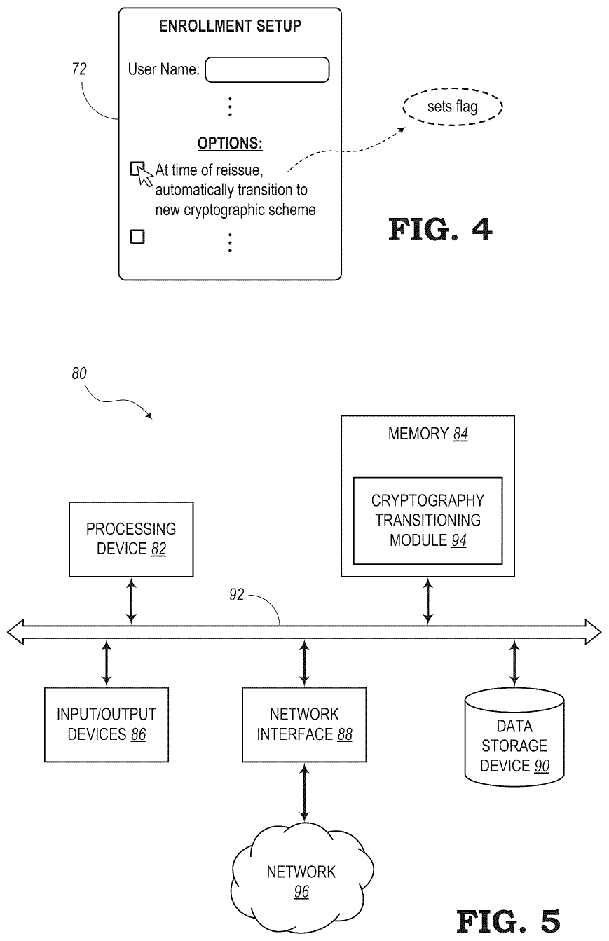

FIG. 4 is a diagram illustrating an embodiment of an enrollment setup page 72, which may be part of an enrollment process for filling out and submitting a Certificate Signing Request (CSR) for requesting a digital certificate from a CA. As shown in this embodiment, the enrollment setup page 72 may allow a user (e.g., admin) to enter various information regarding the requester's name, organization, address, contact information, type of digital certificate being requested, etc. In addition, the enrollment setup page 72, according to some embodiments, may further include various options. One option pertaining to the various implementations discussed in the present disclosure include a choice of selecting an action, where, at the time of reissue of the certificate, the admin may wish to have the certificate automatically transitioned to a new cryptographic scheme, which may already exist or may exist in the future. The option, for example, may be presented as a check box as is shown in FIG. 4 and may specifically state: “At time of reissue, automatically transition to new cryptographic scheme.” In other embodiments, the auto-transitioning option may be presented in other forms, using different terminology, and/or may be selected using other selection mechanisms, as well as at any time including at the enrollment process but also after such as by adding this option at a later date.

### Computer System of Root or End Entity

FIG. 5 is a block diagram illustrating an embodiment of a computing system 80 of a Root (or CA) (e.g., Root 14, 32, 42, 52, 62a, 62b, etc.) or an end entity (e.g., end entity 18, 36, 46, 56, 66, etc.) used in a communication network and/or certificate chain. In the illustrated embodiment, the computing system 80 may be a digital computing device that generally includes a processing device 82, memory 84, Input/Output (I/O) device 86 (e.g., keyboard, keypad, mouse, display monitor, etc.), a network interface 88, and a data storage device 90 (e.g., database). It should be appreciated that FIG. 5 depicts the computing system 80 in a simplified manner, where some embodiments may include additional components and suitably configured processing logic to support known or conventional operating features. The components (i.e., 82, 84, 86, 88, 90) may be communicatively coupled via a local interface 92. The local interface 92 may include, for example, one or more buses or other wired or wireless connections. The local interface 92 may also include controllers, buffers, caches, drivers, repeaters, receivers, among other elements, to enable communication. Further, the local interface 92 may include address, control, and/or data connections to enable appropriate communications among the components 82, 84, 86, 88, 90.

The computing system 80 may be suitable for implementing the present embodiments and may include one or more processing devices configured to execute instructions stored in the memory 84. The memory 84 may comprise volatile memory (e.g., RAM) and non-volatile memory (e.g., ROM, flash memory) for storing data and program instructions. The I/O devices 86, such as keyboards, mice, displays, and other periphery devices, facilitate user interaction with the computing system 80. Additionally, the network interface 88 enables communication with external devices and networks, allowing for data exchange and remote access. The computing system 80 further includes the data storage device 90 for storing and managing data relevant to the various embodiments described herein. The local interface 92 (or bus interface) facilitates communication between the various components of the computing system 80. In operation, the processing device 82 is configured to execute instructions retrieved from the memory 84, interact with the I/O devices 86, communicate over the network interface 88, access and manipulate data stored in the data storage device 90, and utilize the local interface 92 to coordinate data transfer between components, thereby implementing the functionality of the embodiments of the present disclosure.

In particular, the computing system 80 may include a cryptography transitioning module 94, which may be implemented in any suitable form of software or firmware and stored in the memory 84 and/or hardware and configured in the processing device 82. Essentially, the cryptography transitioning module 94 may be stored in a non-transitory computer-readable medium and may include computer logic or code having instructions that enable or cause the processing device 82 to perform certain functions as described in the present disclosure, particularly to transition a digital certificate from one type to another type over the same or different certificate chains.

### Setting Up the Automatic Transitioning Option

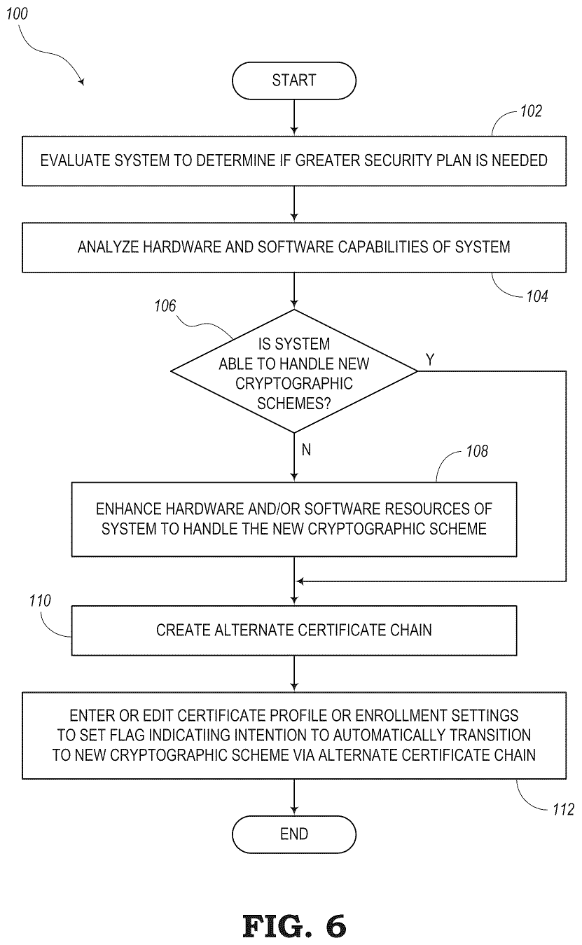

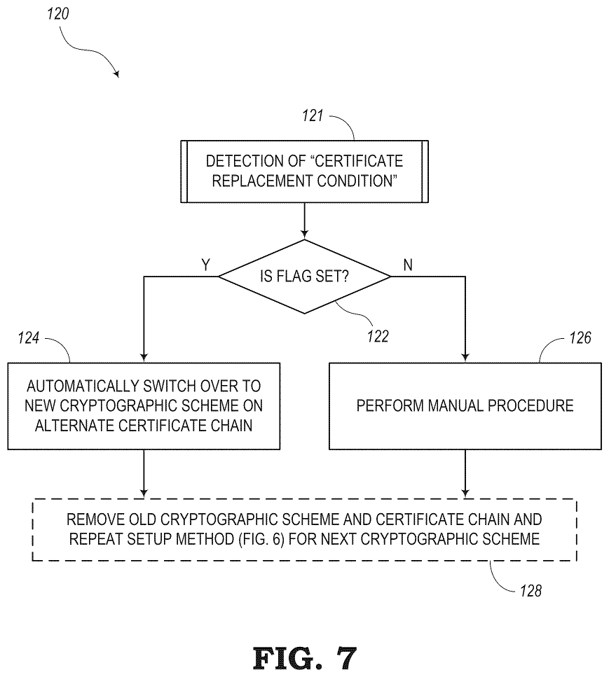

FIG. 6 is a flow diagram illustrating an embodiment of a method 100 for setting up an automatic transitioning mode. The method 100 may be performed by the end entity 18, 36, 46, 56, 66, 80, etc. and may include assistance from the Root 14, 32, 42, 52, 62a, 62b, 80, etc. As shown, the method 100 includes a step of evaluating a system (e.g., end entity) to determine if a greater security plan is needed, as indicated in block 102. The method 100 further includes a step of analyzing the hardware and/or software capabilities of the system, as indicated in block 104.

The method 100 further includes determining if the system is able to handle a new cryptographic scheme that may be available (e.g., on another certificate chain), as indicated in decision block 106. If the system is capable, the method 100 skips the next block (block 108 and proceeds to block 110. Otherwise, if it is determined that the system is not capable of handling the new cryptographic scheme, the method goes to block 108. As indicated in block 108, the method 100 includes enhancing the hardware and/or software resources of the system as needed to be able to handle the new cryptographic scheme or to meet other criteria. As indicated in block 110, the method 100 includes a step of creating an alternate certificate chain, which may be a parallel chain or may be employed on a same or similar chain in a hybrid manner. This step (block 110) may further include handshaking procedures with one or more Roots and ICAs (e.g., ClientHello) to exchange information about the system's capacity and required capacity for handling the new cryptographic scheme. Block 110 may also include various negotiations for maneuvering or directing various certificate chains to adequately request (CSR) and receive issued certificates when such a time arises.

At this point, the method 100 further includes a step, as indicated in block 112, of allowing a user to enter or edit certificate profile information, enrollment settings, CSRs, etc. set a specific flag (e.g., auto-transition option shown in FIG. 4). The flag in this embodiment is configured for indicating an intention to automatically transition from an old (currently used) cryptographic scheme to the new cryptographic scheme via the alternate certificate chain. Also, while described as a flag, those skilled in the art will recognize this can be any type of data that is used to indicate the automatic transition, e.g., a bit, a check box, a selection, etc.

### Seamless and Automatic Cryptography Transitioning Methods

FIG. 7 is a flow diagram illustrating an embodiment of a method 120 for upgrading cryptography when it is determined that a current certificate is ready to be replaced or reissued. Upon waiting for and detecting the existence of a “certificate replacement condition,” as indicated in block 121, the method 120 proceeds to decision block 122. The certificate replacement condition may include any one of several situations in which a certificate may need to be replaced or reissued. Certificates, particularly SSL/TLS certificates, should normally be periodically reissued due to several factors that ensure the ongoing security and integrity of the cryptographic trust model. Certificates may be replaced or reissued when they are near their expiration date. Digital certificates have a finite lifespan, typically lasting one to three years, depending on the issuing CA. Certificates expire to ensure that the cryptographic keys and security protocols remain up to date. As technologies evolve, algorithms or encryption standards may become outdated or vulnerable, so periodically reissuing certificates ensures the use of current, secure practices.

Additionally, the public and private keys associated with certificates may be periodically renewed to prevent the possibility of key compromise or vulnerabilities over time. Reissuing a certificate involves generating a new key pair, which increases security by ensuring that even if old keys are compromised, the new set will be secure. Also, there may be changes in the details of an organization, such as company name, domain names, contact information, etc., which may be included in the certificate.

In some cases, a certificate replacement condition may include a situation where a certificate is revoked. For example, if a certificate is compromised, such as if the private key is stolen or if the issuing CA is no longer trusted, the certificate would normally be revoked and/or reissued. Reissuing with a new certificate ensures that the old, compromised certificate is no longer valid. Also, a certificate may need to be replaced when there are updates to CA policies. Occasionally, CAs update their policies, requiring a reissue to comply with new security standards, such as using stronger encryption algorithms or moving to more secure cryptographic protocols. Furthermore, another certificate replacement condition may include changes in an existing certificate chain 12, 38, 48a, 48b, 58a, 58b, 68a, 68b, etc., which may include changes to the Roots and/or ICAs.

Therefore, upon detecting the certificate replacement condition (block 121), the method 120 includes determining if the specific flag is set, as indicated in decision block 122. If the flag is set (e.g., one, on, high, etc.), the method 120 goes to block 124, which includes a step of automatically switching over to the new cryptographic scheme on the alternate certificate chain. However, if the flag is not set (e.g., zero, off, low, etc.), the method 120 goes to block 126, which includes a step of allowing the user (e.g., admin) to perform a manual procedure to update the certificate. In other words, if the flag is not set, the end entity may be exposed to attacks while the admin has to manually perform various tasks to get the system running securely. The manual steps, for example, may include manually checking what security plans may be available, analyzing the hardware and software of the system to determined what it might be capable of handling, upgrading various hardware and software systems as needed to get up to code and to meet certain security criteria, manually creating an alternate certificate chain, enrolling in a new certificate that may meet new needs, etc. Once the cryptographic scheme is upgraded, changed, replaced, or reissued, the method 120 proceeds to block 128, which may be optional in some embodiments. Block 128 indicates that the method 120 may include a step of removing the old cryptographic scheme and certificate chain and optionally repeating the setup method of FIG. 6 in order to prepare for the next cryptographic update.

In the context of reissuing a certificate, an alternate certificate chain may refer to providing a different chain of trust that links the reissued end entity certificate to a different ICA or Root, such as the alternate chains described with respect to FIGS. 2 and 3A-3C. The alternate certificate chain may include an end entity certificate (the replaced or reissued certificate), intermediate (ICA) certificates, and the root certificate, which form the complete trust hierarchy necessary for validating the certificate.

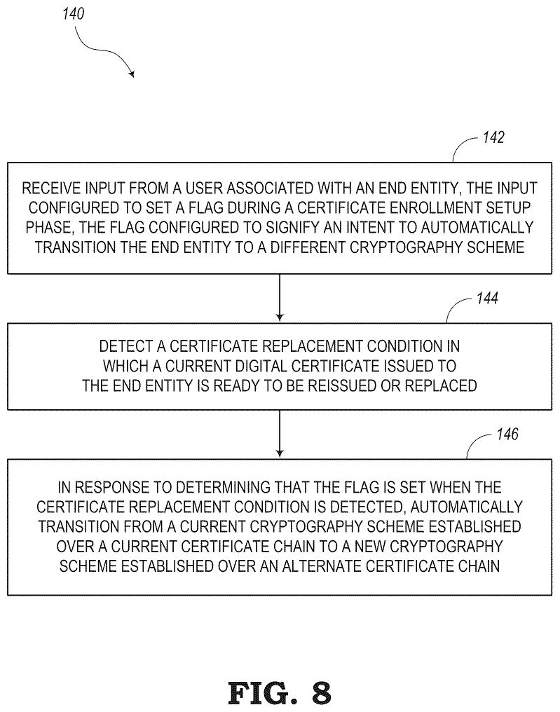

FIG. 8 is a flow diagram illustrating a general embodiment of a method 140 to be executed by an end entity for automatically and seamlessly transitioning to a new cryptography scheme. According to this embodiment, the method 140 includes a step of receiving input from a user associated with the end entity, as indicated in block 142, wherein the input is configured to set a flag during a certificate enrollment setup phase. Also, the flag is configured to signify an intent to automatically transition the end entity to a different cryptography scheme. The method 140 further includes a step of detecting a certificate replacement condition in which a current digital certificate issued to the end entity is ready to be reissued or replaced, as indicated in block 144. In response to determining that the flag is set when the certificate replacement condition is detected, the method 140 includes a step of automatically transitioning from a current cryptography scheme established over a current certificate chain to a new cryptography scheme established over an alternate certificate chain, as indicated in block 146.

In some embodiments, the method 140 may further include a step of receiving a new digital certificate encrypted with the new cryptography scheme from a CA via the alternate certificate chain for replacing the current digital certificate. The step of automatically transitioning from the current cryptography scheme to the new cryptography scheme (block 146) may include a seamless transition from the current digital certificate to the new digital certificate.

Before automatically transitioning from the current cryptography scheme to the new cryptography scheme, the method may further include a) determining if hardware and/or software resource qualifications of the end entity include capabilities sufficient to handle the new cryptography scheme, and b) upon confirming that the hardware and/or software resources include sufficient capabilities, transitioning to the new cryptography scheme. Also, according to some implementations, the action of confirming sufficient capabilities may include exchanging data with a CA via a handshaking procedure performed during the certificate enrollment setup phase.

Furthermore, according to some embodiments, the current cryptography scheme described herein may be a classical or legacy cryptography scheme, and the new cryptography scheme described herein may be a Post-Quantum Cryptography (PQC) scheme. The classical or legacy cryptography scheme, for example, may include one or more of RSA, ECC, SSL, and TLS encryption. In other embodiments, the current cryptography scheme described herein may be a Post-Quantum Cryptography (PQC) scheme, and the new cryptography scheme described herein may be an alternative PQC scheme (e.g., PQC developed in the future that can be used). The PQC scheme, for example, may include one or more of lattice-based, hash-based, multivariate polynomial, SLH-DSA, SPHINCS+, ML-DSA, and/or Dilithium encryption, and the alternative PQC scheme, for example, may include a greater level of encryption than the PQC scheme.

In some embodiments, the current certificate chain and alternate certificate chain may be established as parallel chains. Each of the current certificate chain and alternate certificate chain, for instance, may be a trust hierarchy having one or two Roots or Certificate Authorities (CAs) at the top of the trust hierarchy and one or more Intermediate CAs (ICAs) positioned between an associated Root and the end entity in the trust hierarchy. A Root certificate is issued to each Root and an ICA certificate is issued to each ICA. The end entity, according to various implementations, may be associated with a server, web server, Content Delivery Network (CDN), and/or client-to-client device configured for Transport Layer Security (TLS) or mutual TLS (mTLS) communications with users or clients. The end entity, according to other implementations, may be associated with an Internet of Things (IoT) device, embedded device, Trusted Platform Module (TPM), Online Certificate Status Protocol (OCSP) responder, and/or Hardware Security Module (HSM). HSMs, also referred to as “roots of trust,” are physical devices that protect cryptographic keys and data used for encryption, decryption, authentication, and digital signing. They also prevent unauthorized users from accessing sensitive data, safeguard and manage secrets (e.g., keys), perform encryption and decryption functions for digital signatures, etc.

The certificate replacement condition (described in block 144) may be defined as one or more of a) an impending expiration of the current digital certificate, b) an impending due date for renewal of a key pair of the current digital certificate, c) availability of the new cryptography scheme, d) changes in the current certificate chain, e) availability of the alternate certificate chain, f) an upgrade to hardware and/or software resources associated with the end entity, g) changes in organizational parameters associated with the end entity, h) revocation of the current cryptography scheme, and i) detection of one or more vulnerabilities or compromises of the current cryptography scheme. Furthermore, according to various implementations, the certificate enrollment setup phase may be related to a key negotiation or key exchange phase of a certificate management process and/or may be related to preparing and transmitting a CSR from the end entity to a CA. The method 140 may further be defined whereby the new cryptography scheme and alternate certificate chain are configured to comply with public trust standards, protocols, and regulations defined by the National Institute of Standards and Technology (NIST), the Cybersecurity and Private Professionals (CAPP) Forum, and/or the Commercial National Security Agency (CNSA).

### Additional Considerations

A certificate chain has the Roots, ICAs, and the end entity. The entire chain (or hierarchy) uses one type of encryption algorithm, which could implement a pure classical/legacy encryption or a pure PQC encryption. Having parallel certificate chain would normally be too computationally expensive because they would include two of everything. Not only is this computationally restrictive, but it also requires setting up another PKI to do the same thing, but with different algorithms. Not every client might be able to support that. Also, this strategy can get quite messy. Others believe that hybrid strategies are also too messy.

A client (e.g., end entity) that does not have the capacity (e.g., hardware and/or software resources) to do PQC (or another level of security cryptography), the client will just use the chain that does classical. If the client is only able to PQC but not the cryptography of lesser strength, it will just use the PQC. Nonetheless, the client will normally just use one, since different cryptographic schemes are usually not used at the same time by the same client.

In cybersecurity, public trust and private trust are both important for public key infrastructure (PKI). Public trust is used for publicly accessible websites and interactions, while private trust is used for internal organizational websites and servers. The trust level of public trust is automatically trusted by web browsers and operating systems, while private trust needs to be manually installed or configured. Also, public trust is intended to be trusted by the general public, while private trust is often used within a single organization or between known parties.

The embodiments of the present disclosure may include various workflows and/or configurations where two parallel or coexisting chains are implemented. Again, this does not need to be implemented in the hybrid certificate sense. They may both be running together using a composite methodology or a catalyst methodology, which, again, may be resource intensive or computationally expensive.

The workflows and configurations may allow someone (e.g., admin) to essentially create a chain. When they have the alternative chain set up in their configuration or their workflow, at a point of renewal or reissue, the flag can be monitored. When it is time for the renewal or reissue, the systems and methods may be configured to basically swap over to using the new chain, which may include a) switching from a normal or classical algorithm to a PQC algorithm, b) switching from one normal or classical algorithm to another (e.g., RSA to ECC), or c) switching from one PQC algorithm to another (e.g., Dilithium to a post-PQC algorithm developed in the future.

One strategy for CAs may be to offer two or three selections regarding PQC algorithms. PQC algorithms may have completely different performances. For example, CAs may use SPHINCS+, which may be referred to as State-Less Hash-based Digital Signature Algorithm (SLH-DSA), which may have a lower performance strength than another one, such as Dilithium or Module-Lattice-based Digital Signature Algorithm (ML-DSA). As new PQC algorithms are developed, they can replace older models. This strategy may decrease the risk of attacks. Also, if one algorithm is determined to be compromised, or if it is broken by post-quantum computing equipment, the embodiments herein may include transitioning to another algorithm, which may result in seamless system operation and continued security.

In addition, there is a need to further develop PQC algorithms to meet the attack threats of post-quantum computers. There is a recommendation from Commercial National Security Agency (CNSA) that, for example, requires computing systems, certificates, etc. to be switched to PQC by 2033. Therefore, organizations and individual users will want to incorporate PQC certificates in the near future in anticipation of greater and greater threats. However, if at some point before 2033, an end entity has some issue, they could reissue a new chain with PQC (or some other intermediate algorithm having security strength between today's algorithms and the predicted level of PQC needed in 2033). The end entity would have that ability now to be proactive and set up the parallel chain in advance of any issues. This can give reassurance to the users and can allow continued operation while looking to the future. Therefore, new configurations can be engaged and enrollment with transitioning options for future (currently unknown) algorithms may be used as they are developed. This can enable a seamless for clients, where a safety mechanism can be put in place, that, should something bad happen, they can seamlessly transition to PQC in a hands-free (automatic) manner, because they were able to prepare themselves for unexpected attacks or compromises that may arise at any time. This allows clients to basically be PQC-ready to some extent if reissue or other certificate replacement condition is detected.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method, executed by an end entity, comprising steps of:
responsive to receiving input from a user associated with the end entity, the input configured to set a flag, the flag configured to signify an intent to automatically transition the end entity to a different cryptography scheme, detecting a certificate replacement condition in which a current digital certificate issued to the end entity is ready to be reissued or replaced; and
in response to determining that the flag is set when the certificate replacement condition is detected, automatically transitioning from a current cryptography scheme established over a current certificate chain to a new cryptography scheme established over an alternate certificate chain.

2. The method of claim 1, further comprising a step of receiving a new digital certificate encrypted with the new cryptography scheme from a Certificate Authority (CA) via the alternate certificate chain for replacing the current digital certificate.

3. The method of claim 2, wherein the step of automatically transitioning from the current cryptography scheme to the new cryptography scheme includes a seamless transition from the current digital certificate to the new digital certificate.

4. The method of claim 1, wherein, before automatically transitioning from the current cryptography scheme to the new cryptography scheme, the method further comprises steps of:
determining if hardware and/or software resources of the end entity include capabilities sufficient to handle the new cryptography scheme, and
upon confirming that the hardware and/or software resources include sufficient capabilities, transitioning to the new cryptography scheme.

5. The method of claim 4, wherein confirming sufficient capabilities includes exchanging data with a Certificate Authority (CA) via a handshaking procedure performed during a certificate enrollment setup phase.

6. The method of claim 1, wherein the current cryptography scheme is a classical or legacy cryptography scheme, and the new cryptography scheme is a Post-Quantum Cryptography (PQC) scheme.

7. The method of claim 6, wherein the classical or legacy cryptography scheme includes one or more of RSA, ECC, SSL, and TLS encryption.

8. The method of claim 1, wherein the current cryptography scheme is a first Post-Quantum Cryptography (PQC) scheme, and the new cryptography scheme is an a second PQC scheme.

9. The method of claim 8, wherein the first PQC scheme include one or more of lattice-based, hash-based, multivariate polynomial, SLH-DSA, SPHINCS+, ML-DSA, and/or Dilithium encryption, and wherein the second PQC scheme includes a greater level of encryption than the first PQC scheme.

10. The method of claim 1, wherein the current certificate chain and alternate certificate chain are established as parallel chains.

11. The method of claim 1, wherein each of the current certificate chain and alternate certificate chain is a trust hierarchy having one or two Roots or Certificate Authorities (CAs) at a top of the trust hierarchy and one or more Intermediate CAs (ICAs) positioned between an associated Root and the end entity in the trust hierarchy, and wherein a Root certificate is issued to each Root and an ICA certificate is issued to each ICA.

12. The method of claim 1, wherein the end entity is associated with a server, web server, Content Delivery Network (CDN), or client-to-client device configured for Transport Layer Security (TLS) or mutual TLS (mTLS) communications with users or clients.

13. The method of claim 1, wherein the end entity is associated with an Internet of Things (IoT) device, embedded device, Trusted Platform Module (TPM), Online Certificate Status Protocol (OCSP) responder, and/or Hardware Security Module (HSM).

14. The method of claim 1, wherein the certificate replacement condition is defined as one or more of a) an impending expiration of the current digital certificate, b) an impending due date for renewal of a key pair of the current digital certificate, c) availability of the new cryptography scheme, d) changes in the current certificate chain, e) availability of the alternate certificate chain, f) an upgrade to hardware and/or software resources associated with the end entity, g) changes in organizational parameters associated with the end entity, h) revocation of the current cryptography scheme, and i) detection of one or more vulnerabilities or compromises of the current cryptography scheme.

15. The method of claim 1, wherein the flag is set during a certificate enrollment setup phase which is a key negotiation or key exchange phase of a certificate management process and/or is related to preparing and transmitting a Certificate Signing Request (CSR) from the end entity to a Certificate Authority (CA).

16. The method of claim 1, wherein the new cryptography scheme and the alternate certificate chain are configured to comply with public trust standards, protocols, and regulations defined by National Institute of Standards and Technology (NIST), the Cybersecurity and Private Professionals (CAPP) Forum, and/or Commercial National Security Agency (CNSA).

17. An end entity comprising:
a processing device; and
memory configured to store computing logic having instructions that, when executed, enable the processing device to
responsive to a received input from a user associated with the end entity, the input configured to set a flag, the flag configured to signify an intent to automatically transition the end entity to a different cryptography scheme, detect a certificate replacement condition in which a current digital certificate issued to the end entity is ready to be reissued or replaced, and
in response to determining that the flag is set when the certificate replacement condition is detected, automatically transition from a current cryptography scheme established over a current certificate chain to a new cryptography scheme established over an alternate certificate chain.

18. The end entity of claim 17, wherein, before automatically transitioning from the current cryptography scheme to the new cryptography scheme, the instructions are further configured to enable the processing device to:
exchange data regarding capabilities of the processing device and the memory with a Certificate Authority (CA) via a handshaking procedure performed during a certificate enrollment setup phase;
determine if the capabilities of the processing device and the memory are sufficient to handle the new cryptography scheme; and
upon confirming that the capabilities are sufficient, transition to the new cryptography scheme.

19. A Certificate Authority (CA) comprising:
a processing device; and
memory configured to store computing logic having instructions that, when executed, enable the processing device to
assist a user, associated with an end entity, with a certificate enrollment setup phase to enable the user to set a flag configured to signify an intent to automatically transition the end entity to a different cryptography scheme,
share resource qualifications with the end entity to assist with determining whether capabilities of hardware and/or software resources of the end entity are sufficient to handle a new cryptography scheme, and
in response to receiving an upgrade request from the end entity based on detection of the flag being set and based on detection of a certificate replacement condition, automatically transitioning from a current cryptography scheme established over a current certificate chain to the new cryptography scheme established over an alternate certificate chain.

20. The CA of claim 19, wherein the instructions further enable the processing device to:
generate a new digital certificate encrypted with the new cryptography scheme; and
deliver the new digital certificate to the end entity via the alternate certificate chain for replacing a current digital certificate by automatically and seamlessly transitioning the end entity from the current cryptography scheme to the new cryptography scheme.
